(19) United States
(12) Patent Application Publication
(10) Pub. No.: US 2010/0086204 A1
(43) Pub. Date: Apr. 8, 2010

(54) SYSTEM AND METHOD FOR CAPTURING AN EMOTIONAL CHARACTERISTIC OF A USER

(75) Inventor: Simon Lessing, Mamo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/244,852

(22) Filed: Oct. 3, 2008

(51) Int. Cl. G06F 17/00; G06F 7/00

(52) U.S. Cl. 382/165; 707/E17.019; 707/E17.009

(57) ABSTRACT

An apparatus and method for collecting viewer information associated with a user while the user is acquiring and/or viewing multimedia content. The viewer information is interpreted to determine an emotional characteristic. The emotional characteristic may be stored with the multimedia content. Interpretation of emotional characteristic can provide several gradations of user's preference (e.g., the degree to which the user likes the content of the multimedia). It also can provide a relative degree of importance of the content to the user. Additionally, interpretation of the emotional characteristic can be made in terms of one or more specific emotions (e.g., happiness, sadness, fear, anger, etc.) evoked by the multimedia content. Emotional characteristics of other user may also be stored in the metadata of the multimedia content.

### TECHNICAL FIELD OF THE INVENTION

The technology of the present disclosure relates generally to detecting viewer information associated with a user that captures and/or views multimedia content with an electronic device and determining an emotional characteristic of the user based on the detected viewer information.

### BACKGROUND

Many types of electronic devices (e.g., portable communication devices, computers, cameras, camcorders, etc.) are capable of capturing and/or displaying still images and/or videos. Such images and/or videos are generally stored on a digital storage device (e.g., a memory or hard disk drive, etc.) associated with the electronic device.

Digital storage devices are increasing in size and in many cases may store thousands of forms of multimedia content (e.g., images, videos, etc.) on a single storage device. The large size of digital storage devices enables an enormous amount of content to be stored on a single digital storage device. With the increase in the size of the digital storage device and the quantity of multimedia content stored therein, it is becoming more and more difficult to find multimedia content on the digital storage device that is especially meaningful to a user or users of the electronic device.

Prior art systems do not identify emotional characteristics experienced by a viewer of the multimedia content, as the viewer acquires the multimedia content and/or views the multimedia content. As a result, meaningful images can be easily lost among other images in a database, since there is nothing in these meaningful images to indicate that these images are meaningful to one or more viewers of the images. The prior art systems also do not track or otherwise store a viewer's identification together with the corresponding content. Therefore, when the system is used by more than one user, it is unable to distinguish how different users react to the content.

Based on the foregoing, a need exists for a device and improved method for obtaining emotional characterization information of users capturing and/or otherwise viewing multimedia content and for using the information to facilitate storage and retrieval of multimedia content.

### SUMMARY

The present disclosure describes a system and method that characterizes an emotional characteristic of a person acquiring multimedia content (e.g., taking a photograph and/or a video) on an electronic device and/or viewing multimedia content on the electronic device. The emotional characteristic may be based on one or more physical and/or physiological characteristic of the person acquiring and/or viewing the multimedia content. The emotional characteristic may be stored with the multimedia content. In addition, emotional characteristics of additional people viewing the multimedia content may also be stored with the multimedia content. The multimedia content may be retrieved based on the one or more emotional characteristics associated with the creator of the multimedia content, a viewer of the multimedia content and/or a subject in the multimedia content.

One aspect of the invention relates to an electronic device, including: a display for presenting multimedia content to an associated user, wherein the multimedia content includes a media component and a metadata component; a first camera configured to obtain viewer information, wherein the viewer information includes at least one physical characteristic associated with the viewer of the multimedia content; a controller coupled to the display and the first camera, wherein when the display presents multimedia content to the associated user, the controller causes the first camera to capture viewer information; and an emotional categorization module coupled to the controller, wherein the module determines at least one emotional characteristic associated with the viewer based on the captured viewer information.

Another aspect of the invention relates to an electronic storage device for storing the at least one emotional characteristic and an identification of the viewer in the metadata component of the multimedia content.

Another aspect of the invention relates to the metadata component also includes an identification of a subject in the multimedia content and at least one emotional characteristic associated with the subject.

Another aspect of the invention relates to the multimedia content is stored in a database.

Another aspect of the invention relates to the metadata component associated with multimedia content is searchable based on the at least one emotional characteristic associated with the viewer and/or a subject of multimedia content.

Another aspect of the invention relates to the media component being at least one selected from a group consisting of an image, a video, a song, or a web page.

Another aspect of the invention relates to the electronic equipment being a general purpose computer.

Another aspect of the invention relates to a second camera coupled to the controller, wherein the second camera is configured to capture a scene that is in a field of view of the second camera.

Another aspect of the invention relates to the display being configured as a viewfinder to display a preview image representing at least a portion of the scene that is in the field of view of the second camera.

Another aspect of the invention relates to when the second camera captures an image of at least the portion of the scene, the controller causes the first camera to capture viewer information.

Another aspect of the invention relates to the electronic storage device storing the at least one emotional characteristic and an identification of the viewer in the metadata component of the multimedia content.

Another aspect of the invention relates to the metadata component includes an identification of a subject of the scene and the at least one emotional characteristic of the subject.

Another aspect of the invention relates to the electronic device being a mobile telephone.

One aspect of the invention relates to a method of detecting an emotional characteristic of a viewer acquiring an image and/or video through an electronic device, the method including: acquiring an image and/or video from a camera; acquiring viewer information from a detector at a time substantially contemporaneous with the step of acquiring the image and/or video, wherein the viewer information includes least one of a physical characteristic associated with the viewer; and processing the viewer information to determine at least one emotional characteristic associated with the viewer.

Another aspect of the invention relates to storing the image and/or video and the emotional characteristic of the viewer in a multimedia file, wherein the image and/or video is stored as a media component and the emotional characteristic is stored as metadata.

Another aspect of the invention relates to storing a plurality of multimedia files in a database, wherein the plurality of the multimedia files include at least one emotional characteristic associated with the viewer of the electronic device.

Another aspect of the invention relates to the database being searchable based at least upon the emotional characteristic associated with the viewer and/or an emotional characteristic associated with a subject of the image and/or video.

Another aspect of the invention relates to acquiring viewer information from additional viewers of the image and/or video; determining at least one emotional characteristic associated with at least one additional viewer and storing the emotional characteristic associated with the additional viewer in the metadata.

One aspect of the invention relates to a method of detecting an emotional characteristic associated with a viewer of an electronic device while viewing multimedia content, the method including: displaying multimedia content on a display of an electronic device to an associated viewer; acquiring viewer information from a detector at a time substantially contemporaneous with the step of displaying multimedia content, wherein the viewer information includes at least one of a physical characteristic associated with the viewer; processing the viewer information to determine an emotional characteristic of the user based upon the viewer information; and storing the emotional characteristic associated with the user in metadata associated with the multimedia content in an electronic storage device.

Another aspect of the invention relates to determining an emotional characteristic of a subject in the multimedia content displayed on the display and also storing the emotional characteristic associated with the subject in electronic storage device.

These and further features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIGS. 1 and 2 are respectively a front view and a rear view of an exemplary electronic device that includes a first and second representative camera assemblies.

FIGS. 3 and 4 are exemplary embodiments of electronic devices in accordance with aspects of the present invention.

FIG. 5 is a schematic block diagram of the exemplary electronic device of FIGS. 1 and 2;

FIGS. 6 and 7 are exemplary methods in accordance with aspects of the present invention.

FIG. 8 is a schematic diagram of an exemplary communication system in accordance with aspects of the present invention.

### DETAILED DESCRIPTION OF EMBODIMENTS

Embodiments will now be described with reference to the drawings, wherein like reference numerals are used to refer to like elements throughout. It will be understood that the figures are not necessarily to scale.

Described below in conjunction with the appended figures are various embodiments of an improved system and method for capturing and sharing multimedia content. In the illustrated embodiments, imaging devices that form part of the system for capturing and/or viewing digital multimedia content are embodied as digital camera assemblies that are made part of respective mobile telephones. It will be appreciated that aspects of the disclosed system and method may be applied to other operational contexts such as, but not limited to, the use of dedicated cameras or other types of electronic devices that include a camera (e.g., personal digital assistants (PDAs), media players, gaming devices, computers, computer displays, portable computers, etc.). The described cameras may be used to capture image data in the form of still images, also referred to as pictures, photographs and photos, but it will be understood that the cameras also may be capable of capturing video images in addition to still images.

The present invention provides an apparatus and method for collecting physical and/or physiological information associated with a user while the user is acquiring and/or viewing multimedia content. The physical and/or physiological information of the user are interpreted to determine an emotional characteristic. The emotional characteristic may be stored with the multimedia content. Interpretation of emotional characteristic can provide several gradations of user's preference (e.g., the degree to which the user likes the content of the multimedia). It also can provide a relative degree of importance of the content to the user. Additionally, interpretation of the emotional characteristic can be made in terms of one or more specific emotions (e.g., happiness, sadness, fear, anger, etc.) evoked by the multimedia content.

In one embodiment, the electronic device includes a display for presenting multimedia content to an associated user, wherein the multimedia content includes a media component and a metadata component. The electronic device includes a first detector (e.g., a camera) configured to obtain viewer information, wherein the viewer information includes at least one viewer characteristic associated with the viewer of the multimedia content. Exemplary viewer characteristics include, for example, physical characteristics (e.g., facial expressions, eye movement, etc.), audible signals from the user, physiological characteristics (e.g., blood pressure, breathing rate, heart rate, galvanic skin response, etc). The electronic device includes a controller coupled to the display and the first detector, wherein when the display presents multimedia content to the associated user, the controller causes the first detector to capture viewer information. The electronic device further includes an emotional categorization module coupled to the controller, wherein the module determines at least one emotional characteristic associated with the viewer based on the captured viewer information.

As used herein, a scene is defined as something seen by a viewer. It can be the place where an action or event occurs, an assemblage of one or more people and/or objects seen by a viewer, a series of actions and events, a landscape or part of a landscape, etc. Scenes recorded or displayed by an image capture device or a viewing device are referred to as multimedia content. Examples of image capture devices include mobile telephones, digital still cameras, video cameras, camcorders, computers, laptops, etc.

People capture images of different scenes for a variety of purposes and applications. Capturing memorable events is one example of an activity that ordinary people, professional photographers, or journalists alike have in common. These events are meaningful or emotionally important to an individual or a group of individuals. Images of such events attract special attention, elicit memories, and evoke emotions, or, in general terms, they produce physical and/or psychological reactions. Often these reactions are accompanied by physiological and/or behavior changes.

Information that represents a user's physical, psychological, physiological, and behavioral reactions to a particular scene or an image of the scene (e.g., multimedia content) may be referred to herein as emotional characteristic information. Emotional characteristic information can include raw physiological and behavioral signals (e.g., galvanic skin response, heart rate, facial expressions, etc.). Such information may be analyzed to determine an emotional category (e.g., fear, anger, happiness, etc.) associated with the user. As used herein, the terms physical, psychological, physiological may be referred to collectively as “physical characteristics” for simplicity purposes.

The emotional characteristic information may be stored in connection with the multimedia content and/or separate from the multimedia content. In addition, the emotional characteristic information may be stored with or without an association with a user identification data. The user identification data can be any type of information that is uniquely associated with a user. The user identification data can be a personal identification code such as a globally unique ID (GUID), user number, social security number, or the like. The user identifier can also be a complete legal name, a nickname, a computer user name, or the like. The user identification data can alternatively include information such as a facial image or description, fingerprint image or description, retina scan, or the like. The user identification data can also be an internet address, mobile telephone number or other identification.

The emotional characteristic information and user identifier may be stored as image “metadata”, which is a term of art used for any information relating to an image. Examples of other types of image metadata that can be incorporated in the personal emotional characteristic information that may be stored in the metadata include information derived from scene images (e.g., emotional characteristics associated with one or more subjects of the multimedia content) and non-image data such as image capture time, capture device, date of capture, image capture parameters, image editing history, viewing device, date of view, image viewing parameters, etc.

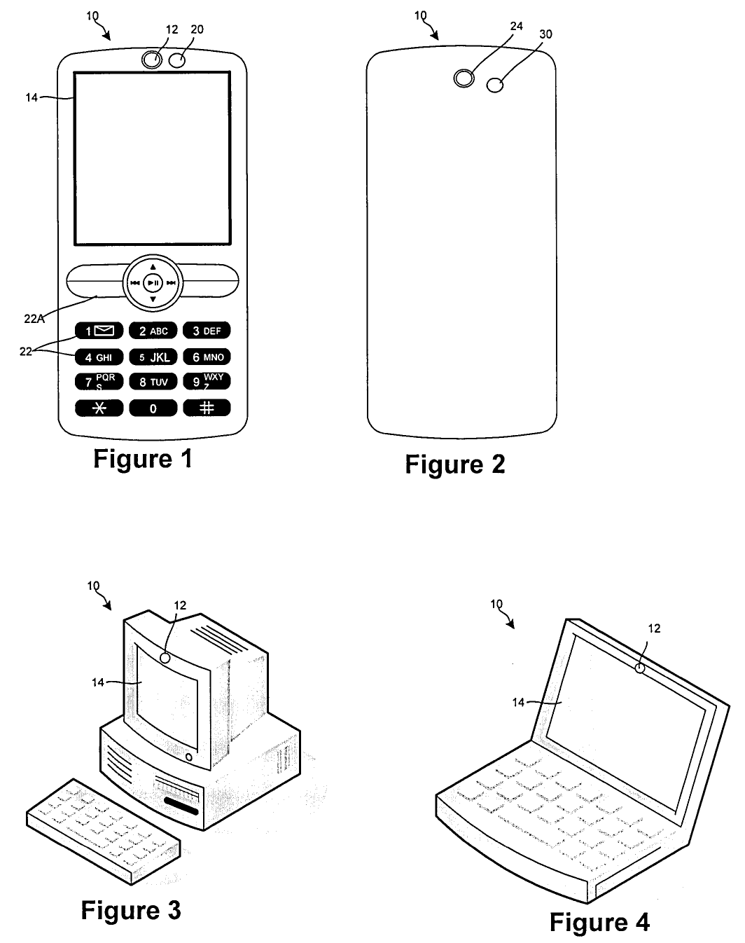

Referring initially to FIGS. 1 and 2, an electronic device 10 is shown. The illustrated electronic device 10 is a mobile telephone. The electronic device 10 includes a detector 12 for capturing one or more physical characteristics of a user of the electronic device 10. The detector 12 may be any type of detector that can detect a physical characteristic associated with the user. For example, the detector 12 may be a camera (e.g., which measures facial expressions, shape of eyes, shape of mouth, structural relationships between facial features, eye movement, changes in skin around a user's eyes, eye characteristics, etc.), a heart rate monitor (e.g., measures a user's pulse), a galvanic skin response sensor(s) (e.g., measures skin conductance (oxygen) signals), an accelerometer (e.g., may be used to detect movement, nervousness of user, etc.), motion detection circuitry (e.g., may be used to detect movement, nervousness of user, etc.), etc. Thus, the detector 12 can be an optical detector, as well as, a non-optical detector. The one or more physical characteristics may be processed to identify an emotional characteristic associated with a user, as the user views and/or acquires multimedia content. As set forth above, the physical characteristics may be physical, psychological, and/or physiological characteristics (e.g., galvanic skin response, heart rate, facial expressions (e.g., shape of eyes, shape of mouth, structural relationships between facial features, eye movement, facial expressions, changes in skin around a user's eyes, eye characteristics, physiological reactions, etc.).

It is emphasized that the electronic device 10 need not be a mobile telephone, but could be a personal computer as illustrated in FIG. 3, a laptop as illustrated in FIG. 4, or any other electronic device that has a detector 12 facing the user during use (while the user is viewing and/or acquiring multimedia content), so that the detector can capture one or more physical characteristics of the user while the user is either taking a photograph and/or video or viewing a photograph or a video on a display 14 of the electronic device 10 and/or coupled to the electronic device 10.

The detector 12 may be arranged as a front facing detector, i.e., the detector faces in a direction towards the user during use of the electronic device 10. The detector 12 may include imaging optics 16 to focus light from a portion of a scene that is within the field-of-view of the detector 12 onto a sensor 18. The sensor 18 may convert the incident light into image data. The imaging optics 16 may include various optical components, such as a lens assembly and components that supplement the lens assembly (e.g., a protective window, a filter, a prism, and/or a mirror). The imaging optics 16 may be associated with focusing mechanics, focusing control electronics, optical zooming mechanics, zooming control electronics, etc. Other detector components may include a flash 20 to provide supplemental light during the capture of one or more physical characteristics of the user, a light meter, display 14 for functioning as an electronic viewfinder and as part of an interactive user interface, a keypad and/or buttons 22 for accepting user inputs, an optical viewfinder (not shown), and any other components commonly associated with such detectors.

One of ordinary skill in the art will appreciate that while the above description is provided with the detector 12 being a camera, other design considerations may be utilized based on the type of detector or detectors being used. For example, if a galvanic skin response sensor is utilized, the detector may be positioned to obtain optimum galvanic response signals, which may be on the front, sides or back of the electronic device.

An electronic controller 23 may control operation of the detector 12. The controller 23 may be embodied, for example, as a processor that executes logical instructions that are stored by an associated memory, as firmware, as an arrangement of dedicated circuit components, or as a combination of these embodiments. Thus, methods of operating the detector 12 may be physically embodied as executable code (e.g., software) that is stored on a machine readable medium and/or may be physically embodied as part of an electrical circuit. In another embodiment, the functions of the electronic controller 23 may be carried out by a control circuit 32 that is responsible for overall operation of the electronic device 10. In this case, the controller 23 may be omitted. In another embodiment, detector 12 control functions may be distributed between the controller 23 and the control circuit 32.

The electronic device 10 may also include a camera 24. The camera 24 may be arranged as a typical camera assembly that includes imaging optics 26 to focus light from a portion of a scene that is within the field-of-view of the camera 24 onto a sensor 28. The sensor 28 converts the incident light into image data. The imaging optics 26 may include various optical components, such as a lens assembly and components that supplement the lens assembly (e.g., a protective window, a filter, a prism, and/or a mirror). The imaging optics 26 may be associated with focusing mechanics, focusing control electronics, optical zooming mechanics, zooming control electronics, etc. Other camera components may include a flash 30 to provide supplemental light during the capture of image data for a photograph, a light meter, display 14 for functioning as an electronic viewfinder and as part of an interactive user interface, a keypad and/or buttons 22 for accepting user inputs, an optical viewfinder (not shown), and any other components commonly associated with cameras. One of the keys or buttons 22 may be a shutter key that the user may depress to command the taking of a photograph and/or video through camera 24.

An electronic controller 30 may control operation of the detector 12 and the camera 24. The controller 30 may be embodied, for example, as a processor that executes logical instructions that are stored by an associated memory, as firmware, as an arrangement of dedicated circuit components, or as a combination of these embodiments. Thus, methods of operating the detector 12 and/or camera 24 may be physically embodied as executable code (e.g., software) that is stored on a machine readable medium and/or may be physically embodied as part of an electrical circuit. In another embodiment, the functions of the electronic controller 30 may be carried out by a control circuit 32 that is responsible for overall operation of the electronic device 10. In this case, the controller 30 may be omitted. In another embodiment, detector 12 and/or camera 24 control functions may be distributed between the controller 30 and the control circuit 32.

It will be understood that the camera 24, and optionally detector 12, may generate output image data at a predetermined frame rate to generate a preview video signal that is supplied to the display 14 for operation as an electronic viewfinder. Typically, the display 14 is on an opposite side of the electronic device 10 from the camera 24 (and on the same side as the field of view for the detector 12). In this manner, a user may point the camera 24 in a desired direction and view a representation of the field-of-view of the camera 24 on the display 14. As such, the camera 24 may have a point-of-view, or perspective. The point-of-view is a combination of a location of the camera 24 and a direction in which the camera is aimed by the user. The point-of-view of the camera 24, in combination with characteristics of the imaging optics 26 and optical settings, such as an amount of zoom, establish the field-of-view of the camera 24.

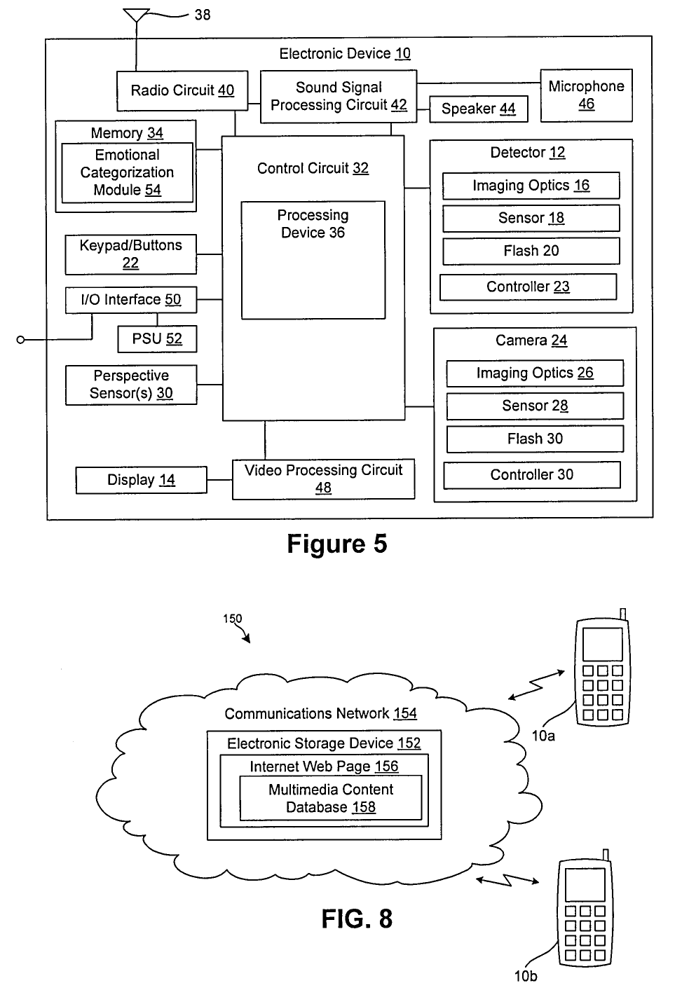

With additional reference to FIG. 5, features of the electronic device 10, when implemented as a mobile telephone, will be described with continued reference to FIGS. 1 and 2. As indicated, the electronic device 10 includes display 14. The display 14 displays information to a user such as operating state, time, telephone numbers, contact information, various menus, etc., that enable the user to utilize the various features of the electronic device 10. In addition, as discussed above the display 14 may function as an electronic view finder for viewing scene information associated with detector 12 and/or camera 24. Additionally, the display 14 displays multimedia content for the user to view.

Also, the key and/or buttons 22 may provide for a variety of user input operations, including call operations, messaging operations, Internet browsing, menu navigation, game playing, multimedia content playback and so forth. Although not illustrated, the keys and/or buttons 22 may include alphanumeric character keys.

The electronic device 10 may include call circuitry that enables the electronic device 10 to establish a call and/or exchange signals with a called/calling device, which typically may be another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VoIP) call that is established over a packet-switched capability of a cellular network or over an alternative packet-switched network, such as WiFi (e.g., a network based on the IEEE 802.11 standard), WiMax (e.g., a network based on the IEEE 802.16 standard), etc. Another example includes a video enabled call that is established over a cellular or alternative network.

The electronic device 10 may be configured to transmit, receive and/or process data, such as text messages, instant messages, electronic mail messages, multimedia messages, image files, video files, audio files, ring tones, streaming audio, streaming video, data feeds (including podcasts and really simple syndication (RSS) data feeds), and so forth. Processing data may include storing the data in the memory 34, executing applications to allow user interaction with the data, displaying video and/or image content associated with the data, outputting audio sounds associated with the data, and so forth.

The electronic device 10 may include the primary control circuit 32 that is configured to carry out overall control of the functions and operations of the electronic device 10. The control circuit 32 may include a processing device 36, such as a central processing unit (CPU), microcontroller or microprocessor. The processing device 36 may execute code that implements the various functions of the electronic device 10. The code may be stored in a memory (not shown) within the control circuit 32 and/or in a separate memory, such as the memory 34, in order to carry out operation of the electronic device 10.

Continuing to refer to FIG. 5, the electronic device 10 includes an antenna 38 coupled to a radio circuit 40. The radio circuit 40 includes a radio frequency transmitter and receiver for transmitting and receiving signals via the antenna 38. The radio circuit 40 may be configured to operate in a mobile communications system and may be used to carryout calls and to send and receive data and/or audiovisual content. Receiver types for interaction with a mobile radio network and/or broadcasting network include, but are not limited to, global system for mobile communications (GSM), code division multiple access (CDMA), wideband CDMA (WCDMA), general packet radio service (GPRS), WiFi, WiMax, digital video broadcasting-handheld (DVB-H), integrated services digital broadcasting (ISDB), etc., as well as advanced versions of these standards. It will be appreciated that the antenna 38 and the radio circuit 40 may represent one or more than one radio transceivers.

The electronic device 10 further includes a sound signal processing circuit 42 for processing audio signals transmitted by and received from the radio circuit 40. Coupled to the sound processing circuit 42 are a speaker 44 and a microphone 46 that enable a user to listen and speak via the electronic device 10 as is conventional. The radio circuit 40 and sound processing circuit 42 are each coupled to the control circuit 32 so as to carry out overall operation. Also, the display 14 may be coupled to the control circuit 32 by a video processing circuit 48 that converts video data to a video signal used to drive the display 14.

The electronic device 10 may further include one or more I/O interface(s) 50. The I/O interface(s) 50 may be in the form of typical mobile telephone I/O interfaces and may include one or more electrical connectors. As is typical, the I/O interface(s) 50 may be used to couple the electronic device 10 to a battery charger to charge a battery of a power supply unit (PSU) 52 within the electronic device 10. In addition, or in the alternative, the I/O interface(s) 50 may serve to connect the electronic device 10 to a headset assembly (e.g., a personal handsfree (PHF) device) that has a wired interface with the electronic device 10. Further, the I/O interface(s) 50 may serve to connect the electronic device 10 to a personal computer or other device via a data cable for the exchange of data. The electronic device 10 may receive operating power via the I/O interface(s) 50 when connected to a vehicle power adapter or an electricity outlet power adapter. The PSU 52 may supply power to operate the electronic device 10 in the absence of an external power source.

Other components that are commonly found in mobile telephones 10 may be present, such as a system clock, a local wireless interface (e.g., an infrared transceiver and/or an RF transceiver, such as a Bluetooth transceiver), etc.

The memory 34 may include an emotional categorization module 54. Alternatively, the emotional categorization module 54 may be stored as firmware in the processing device 36 and/or control circuit 32. When stored in memory 34, the emotional categorization module 54 may be coupled to the controller 34 and may determine at least one emotional characteristic associated with the viewer based on the captured viewer information, as discussed below. The emotional categorization module 54 may utilize face and/or emotion detection technology to determine at least one emotional characteristic of a user creating and/or viewing multimedia content on the display 14. One of ordinary skill in the art will readily appreciate that there are a number of ways detect an emotion associated with a user. For example, analyzing a user's face to determine a position of the user's mouth, eyes and/or cheeks, analyzing sound emanating from the user, using galvanic skin response skin conductance signals, etc. may be used to associate an emotion with user. It may also be desirable determine the emotion of a subject in the multimedia content. Any one or more of the above methods may be used to determine the emotion of one or more subjects in the multimedia content.

In addition, it may be desirable to measure a variety of physical characteristics of a user and/or subject to determine a degree of excitement associated with the user or subject. For example, a weighted average may be used to determine an emotional condition of the user when capturing and/or viewing the multimedia content. An exemplary list of emotions and physical characteristics are set forth in Table I.

TABLE I

| Emotion | Facial Expression | Eye Characteristic | Physiological Reactions |
|---|---|---|---|
| Joy | Smile, crinkled skin around | Opened eyelids, dilated | Accelerated heart rate, large |
| | eye corners | pupils, direct gaze | galvanic skin response |
| Fear | Pale skin, trembling lips, | Widely opened eyelids, | Accelerated heart rate, accelerated |
| | chattering teeth | fast blink rate, fixed gaze, | breathing rate, tightened muscles |
| | | dilated pupils | tension, sweaty palms |
| Anger | Lowered brows, flared | Narrowed eyelids, fixed | Deep and rapid breathing, |
| | nostrils, horizontal wrinkles | gaze | increased blood pressure |
| | over nose bridge, tense-mouth | | |
| Surprise | Raised eyebrows, opened | Opened eyelids, fixed gaze | Large galvanic skin response |
| | mouth, wrinkled bro and | | |
| | forehead | | |
| Disgust | Wrinkled nose, raised | Narrowed eyelids, averted | Decreased breathing rate |
| | nostrils, retracted upper lip, | gaze | |
| | visible tongue, lowered | | |
| | brows, | | |
| Sadness | Lowered lips, cheeks and jaw | Narrowed eyelids, tearing | Flaccid muscles, decreased |
| | | eyes, down gaze | breathing rate |

Multimedia content can be further classified using a range of values for these categories, such as strongly happy, somewhat happy, neutral and somewhat sad, and strongly sad, etc. The emotional characteristic in terms of the emotional category may then be stored along with the user identifier as part of the image metadata. It can also be stored in a separate file on the computer together with the image identifier and the user identifier.

The emotional categorization module 54 may be embodied as executable code that is resident in memory 34 and executed by the control circuit 32 and/or electronic controller 30. In one embodiment, the emotional categorization module 54 may be a program stored on a computer or machine readable medium. The emotional categorization module 54 may be a stand-alone software application or form a part of a software application that carries out additional tasks.

It will be apparent to a person having ordinary skill in the art of computer programming, and specifically in application programming for camera, mobile telephones and/or other electronic devices, how to program the electronic device 10 to operate and carry out logical functions associated with the emotional categorization module 54 and how to program the electronic device 10 to operate and carry out logical functions associated with the emotional categorization module 54. Accordingly, details as to specific programming code have been left out for the sake of brevity. Also, while the functions and may be executed by respective processing devices in accordance with an embodiment, such functionality could also be carried out via dedicated hardware or firmware, or some combination of hardware, firmware and/or software.

Also, through the following description, exemplary techniques for detecting an emotional characteristic of a user acquiring and/or viewing multimedia on an electronic device are described. It will be appreciated that through the description of the exemplary techniques, a description of steps that may be carried out in part by executing software is described. The described steps are the foundation from which a programmer of ordinary skill in the art may write code to implement the described functionality. As such, a computer program listing is omitted for the sake of brevity. However, the described steps may be considered an algorithm that the corresponding devices are configured to carry out.

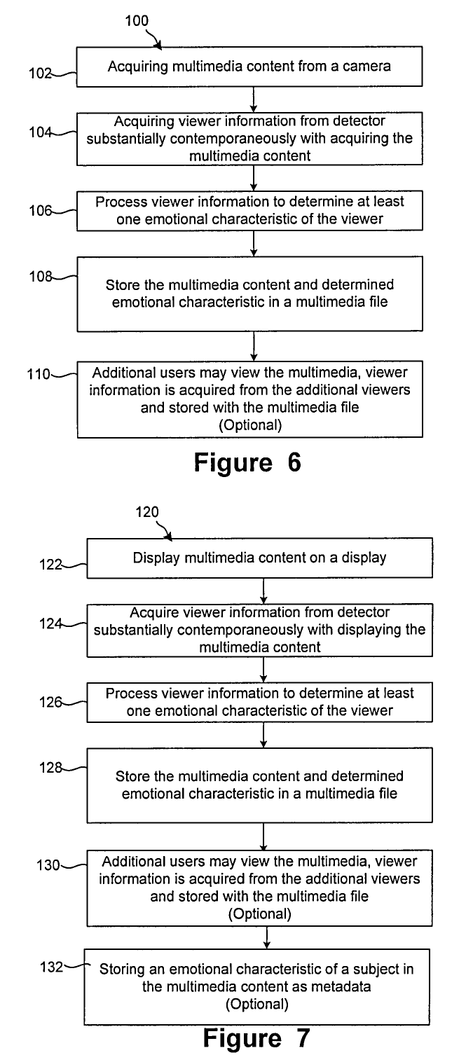

With additional reference to FIG. 6, illustrated are logical operations to implement an exemplary method 100 of detecting an emotional characteristic of a viewer acquiring an image and/or video through an electronic device. One of ordinary skill in the art will appreciate that the logical operations may be configure to occur automatically and/or may be enabled and disabled based on user interaction.

At block 102, the method includes acquiring an image and/or video from a camera 24. The camera 24 may be any suitable imaging and/or video capturing device. The captured image and/or video may be stored in memory 34 or other electronic storage device (not shown).

At block 104, viewer information is acquired from a detector 12 at a time substantially contemporaneous with the step of acquiring the image and/or video. As used herein, substantially contemporaneous means that the duration is such that one or more of the user's physical characteristics are likely to be dependent on the content of the image and/or video. For example, usually this duration will be less than 10 seconds. The detector 12 may be any suitable detector. Suitable detectors include, for example, one or more cameras, a microphone, galvanic skin sensors, heart rate monitors, etc. Viewer information is obtained from the detector 12. The viewer information generally includes at least one of a physical characteristic associated with the viewer. As used herein, a physical characteristic also includes a physiological characteristic associated with the user.

At block 106, the viewer information is processed to determine at least one emotional characteristic associated with the viewer. The viewer information may be processed using off-the-shelf and/or proprietary software and/or hardware to detect facial features and/or emotions. A weighted average of the viewer information may also be processed to assign an emotional characteristic value to the user.

At block 108, the image and/or video along with the emotional characteristic of the viewer may be stored in a multimedia file. In such cases, the image and/or video may be stored as a media component and the emotional characteristic is stored as metadata. The multimedia content may be stored with a plurality of multimedia files in a database. The database may be searchable based on the emotional characteristic associated with the viewer of the electronic device and/or a subject in the multimedia content. In addition, raw images acquired may be stored in a separate file or in the metadata.

Optionally, at block 110, additional users may view the multimedia content, which may be stored on the electronic device 10, on a server (not shown) or any other desired electronic storage device. When the additional users view the multimedia content, viewer information associated with the additional is detected. The viewer information may be used to determine at least one emotional characteristic associated with one or more additional viewers. The emotional characteristic may also be stored in the metadata with other viewer information.

With additional reference to FIG. 7, illustrated are logical operations to implement an exemplary method 120 of detecting an emotional characteristic associated with a viewer of an electronic device while viewing multimedia content. At block 122, multimedia content is displayed on a display of an electronic device to an associated viewer. At block 124, viewer information is acquired from a detector at a time substantially contemporaneous with the step of displaying multimedia content. As stated above, the viewer information includes at least one of a physical characteristic associated with the viewer. At block 126, the viewer information is processed to determine an emotional characteristic of the user based upon the viewer information. At block 128, the emotional characteristic associated with the user is stored in metadata associated with the multimedia content in an electronic storage device.

Optionally, at block 130, additional users may view the multimedia content, which may be stored on the electronic device 10, on a server (not shown) or any other desired electronic storage device. When the additional users view the multimedia content, viewer information associated with the additional is detected. The viewer information may be used to determine at least one emotional characteristic associated with one or more additional viewers. The emotional characteristic may also be stored in the metadata with other viewer information.

Optionally, at block 132, an emotional characteristic of a subject in the multimedia content displayed on the display may also be determined and stored as metadata in the electronic storage device. As stated above, the emotional characteristic of the subject may be determined in any desirable manner (e.g., off-the-shelf software and/or proprietary software and/or hardware).

Referring to FIG. 8, a system 150 in accordance with aspects of the present invention is illustrated. The system may include an electronic storage device 152 that is remotely accessible from one or more users through electronic device 10A, 10B directly and/or through one or more other networks 154 (e.g., the Internet). The electronic storage device 152 may operable to host an Internet web page 156 and/or service. For example, the electronic storage device may host a social networking portal, such as Facebook, MySpace, etc, which allows user to establish an account with the portal and customize one or more web pages 156 to be viewed by others over the Internet.

In one exemplary use case, the user may upload multimedia content that includes a metadata component that identifies an emotion of the author and optionally the subject. Additional viewers may view content and, if they their electronic device is configured to acquire viewer information and determine the emotional condition of the viewer, the viewers emotion and, optionally an identification of the user may be stored with the metadata with the multimedia content at the electronic storage device 152. The metadata of the multimedia content may keep track of all users and their detected emotional conditions and/or a portion of the viewers.

For example, a user utilizing electronic device 10A may acquire multimedia content and upload the content to the electronic storage device 152. The multimedia content includes a media component and a metadata component. The metadata component includes at least one emotional characteristic associated with the user of electronic device 10A. Once uploaded to the electronic storage device 152, the user utilizing electronic device 10B may search for images based on emotional characteristics of the creator, and optionally based on the subject matter and/or emotional characteristics of the subject of the multimedia content. When the user of electronic device 10B decides to view the multimedia content by selecting the multimedia content, the multimedia content is downloaded and displayed to the user of electronic device 10B. At substantially the same time, one or more emotional characteristics associated with the viewer are obtained by electronic device 10B. The emotional characteristics may be uploaded to the electronic storage device and stored with the metadata associated with the multimedia content. At a later time, the user of electronic device 10A may subsequently see the emotional impact of the multimedia content on the user associated with electronic device 10B. Other users may also view emotional impact that the multimedia content had on additional viewers of the multimedia content.

The multimedia content may also be searched by emotional condition of one or more of the viewers, the creator, and/or the subjects of the multimedia content. For example, a database 158 of multimedia content associated with the user account may be searched in any desirable for manner for information contained in the multimedia content and/or metadata. The multimedia content may be searched based upon specific emotions. For example, a viewer may search for multimedia content that shows a subject as being embarrassed or a viewer may search for multimedia content in which the viewer had a particular emotion and/or another viewer had a particular emotion.

In summary, the present disclosure provides that every time an electronic device is used to take a picture or record a video, the device may keep track of the experience and emotion of the user taking the photograph and/or video. By using face and/or emotion detection technology, the emotions of the user taking the photograph and/or video may be ascertained and stored with the image. Furthermore, the same basic approach may be used whenever a user is looking at someone else's photographs and/or videos, to see what which multimedia content that the viewer thought was the most fun. The content of the multimedia content may also be factored into the determination of the emotion of the viewer.

Benefits of the present disclosure make it possible for a user to find multimedia content that were most fun to the user, e.g., where the user laughed the hardest when capturing the multimedia content. One user can see what multimedia content other users enjoyed this week, both the other user's multimedia content and other multimedia content, such as videos on YouTube. Users may search multimedia content based on the reaction caused by the content, e.g., identify the top shocking videos in associated with a user, identify what made other users really embarrassed lately, etc. In addition, a user can search for multimedia content where the user had a specific emotion and others and/or the subjects in the multimedia content had specific emotions.

Although certain embodiments have been shown and described, it is understood that equivalents and modifications falling within the scope of the appended claims will occur to others who are skilled in the art upon the reading and understanding of this specification.

What is claimed is:

1. An electronic device, comprising:
a display for presenting multimedia content to an associated user, wherein the multimedia content includes a media component and a metadata component;
a first camera configured to obtain viewer information, wherein the viewer information includes at least one physical characteristic associated with the viewer of the multimedia content;
a controller coupled to the display and the first camera, wherein when the display presents multimedia content to the associated user, the controller causes the first camera to capture viewer information; and
an emotional categorization module coupled to the controller, wherein the module determines at least one emotional characteristic associated with the viewer based on the captured viewer information.

2. The electronic device of claim 1 further including an electronic storage device for storing the at least one emotional characteristic and an identification of the viewer in the metadata component of the multimedia content.

3. The electronic device of claim 2, wherein the metadata component also includes an identification of a subject in the multimedia content and at least one emotional characteristic associated with the subject.

4. The electronic device of claim 3, wherein the multimedia content is stored in a database.

5. The electronic device of claim 4, wherein the metadata component associated with multimedia content is searchable based on the at least one emotional characteristic associated with the viewer and/or a subject of multimedia content.

6. The electronic equipment of claim 5, wherein the media component is at least one selected from a group consisting of an image, a video, a song, or a web page.

7. The electronic equipment of claim 1, wherein the electronic equipment is a general purpose computer.

8. The electronic equipment of claim 1 further including a second camera coupled to the controller, wherein the second camera is configured to capture a scene that is in a field of view of the second camera.

9. The electronic equipment of claim 8, wherein the display is configured as a viewfinder to display a preview image representing at least a portion of the scene that is in the field of view of the second camera.

10. The electronic equipment of claim 9, wherein when the second camera captures an image of at least the portion of the scene, the controller causes the first camera to capture viewer information.

11. The electronic device of claim 10, wherein the electronic storage device stores the at least one emotional characteristic and an identification of the viewer in the metadata component of the multimedia content.

12. The electronic device of claim 11, wherein the metadata component includes an identification of a subject of the scene and the at least one emotional characteristic of the subject.

13. The electronic device of claim 12, wherein the electronic device is a mobile telephone.

14. A method of detecting an emotional characteristic of a viewer acquiring an image and/or video through an electronic device, the method comprising:
acquiring an image and/or video from a camera;
acquiring viewer information from a detector at a time substantially contemporaneous with the step of acquiring the image and/or video, wherein the viewer information includes least one of a physical characteristic associated with the viewer; and
processing the viewer information to determine at least one emotional characteristic associated with the viewer.

15. The method of claim 14 further including storing the image and/or video and the emotional characteristic of the viewer in a multimedia file, wherein the image and/or video is stored as a media component and the emotional characteristic is stored as metadata.

16. The method of claim 15 further including storing a plurality of multimedia files in a database, wherein the plurality of the multimedia files include at least one emotional characteristic associated with the viewer of the electronic device.

17. The method of claim 16, wherein the database is searchable based at least upon the emotional characteristic associated with the viewer and/or an emotional characteristic associated with a subject of the image and/or video.

18. The method of claim 16 further including acquiring viewer information from additional viewers of the image and/or video; determining at least one emotional characteristic associated with at least one additional viewer and storing the emotional characteristic associated with the additional viewer in the metadata.

19. A method of detecting an emotional characteristic associated with a viewer of an electronic device while viewing multimedia content, the method comprising:
displaying multimedia content on a display of an electronic device to an associated viewer;
acquiring viewer information from a detector at a time substantially contemporaneous with the step of displaying multimedia content, wherein the viewer information includes at least one of a physical characteristic associated with the viewer;
processing the viewer information to determine an emotional characteristic of the user based upon the viewer information; and
storing the emotional characteristic associated with the user in metadata associated with the multimedia content in an electronic storage device.

20. The method of claim 19 further including determining an emotional characteristic of a subject in the multimedia content displayed on the display and also storing the emotional characteristic associated with the subject in electronic storage device.
